(19) United States
(12) Patent Application Publication
(10) Pub. No.: US 2025/0362951 A1
(43) Pub. Date: Nov. 27, 2025

(54) DEVICES AND METHODS FOR DISTRIBUTED MEMORY TRANSACTIONS

(71) Applicant: HUAWEI TECHNOLOGIES CO., LTD., Shenzhen (CN)

(72) Inventors: Zvika Rubin, Israel (IL); Uri Hasson, Israel (IL); Eti Siminchi, Israel (IL); Liran Mishali, Munich (DE)

(73) Assignee: HUAWEI TECHNOLOGIES CO., LTD., Shenzhen (CN)

(21) Appl. No.: 19/295,138

(22) Filed: Aug. 8, 2025

Related U.S. Application Data
(63) Continuation of application No. PCT/EP2023/053199, filed on Feb. 9, 2023.

(51) Int. Cl. G06F 9/46; G06F 9/52; G06F 11/14

(52) U.S. Cl. CPC G06F 9/467; G06F 9/52; G06F 11/1469

(57) ABSTRACT

A data processing apparatus (110) for managing a distributed memory transaction on a plurality of objects stored in a plurality of memory nodes (120a-c) is disclosed. The distributed memory transaction includes an execution phase and a subsequent validation and commit phase and the plurality of objects include one or more read-set objects and/or one or more write-set objects. In the validation and commit phase the data processing apparatus (110) is configured to perform the processing stages: (a) lock and validate the one or more write-set objects; (b) validate the one or more read-set objects; and (c) commit to changing and unlocking the one or more write-set objects. The data processing apparatus (110) is configured to perform the processing stages (a) and (b) and/or the processing stages (b) and (c) of the validation and commit phase substantially in parallel.

### CROSS-REFERENCE TO RELATED APPLICATIONS

This application is a continuation of International Application No. PCT/EP2023/053199, filed on Feb. 9, 2023, the disclosure of which is hereby incorporated by reference in its entirety.

### FIELD

The present disclosure relates to information processing technology including devices and methods for distributed memory transactions.

### BACKGROUND

Distributed memory-centric transactions are memory-accessing transactions that span over multiple physical or virtual memory nodes in a network of memory nodes. One of the main challenges for distributed memory transactions, which usually includes accessing and/or manipulating memory objects on a plurality of different memory nodes, is maintaining a consistent view of the memory at all times. Managing such transactions is complex as it requires coordinating the steps executed on the different memory nodes in order to preserve the atomicity (all-or-nothing nature) of the transaction under conditions of concurrency while keeping the memory consistent. Usually, no transaction is allowed to act upon partial results of other transactions and each transaction is taking place starting at a coherent view of the memory that is a result of prior transactions that were finished successfully.

Optimistic approaches for distributed memory transactions achieve high performance in a low data contention environment by utilizing lock-free data structures instead of computationally expensive locks. Optimistic approaches usually rely on an execution phase that performs the required read-memory and write-to-memory operations on an isolated working-area without taking any lock, and a commit and validation phase for validating that the view it had during the execution phase is still valid (possibly locking for a short time the so called write-set objects) and depending on the result of that validation, making the required changes in-place, i.e. in the real place in memory and then unlocking all the objects it has locked before.

### SUMMARY

Embodiments of the present disclosure provide improved devices and methods for distributed memory transactions.

According to a first aspect, an apparatus (herein also referred to as coordinator) for managing a distributed memory transaction on a plurality of objects stored in a plurality of memory nodes of a network of memory nodes is provided. The distributed memory transaction includes an execution phase and a subsequent validation and commit phase and the plurality of objects include one or more read-set objects and/or one or more write-set objects. In the validation and commit phase the apparatus is configured to perform the following processing stages:
(a) lock and validate the one or more write-set objects;
(b) validate the one or more read-set objects; and
(c) commit to changing and unlocking the one or more write-set objects.

The apparatus is configured to perform the processing stages (a) and (b) and/or the processing stages (b) and (c) of the validation and commit phase substantially in parallel. Thus, an improved apparatus is provided for managing distributed memory transactions in an accelerated and more efficient way.

In a further possible implementation form, in the execution phase the apparatus is further configured to obtain an atomic version number of each of the plurality of objects for validating the one or more write-set objects and/or the one or more read-set objects during the validation and commit phase, for instance, by comparing the object version number obtained in the execution phase with the object version number in the validation and commit phase.

In a further possible implementation form, the apparatus comprises or is implemented as a network interface card (NIC), a memory processor or a hardware accelerator, for instance, of a server.

In a further possible implementation form, the apparatus is a memory node of the plurality of memory nodes. In other words, in an implementation the apparatus, i.e. coordinator itself may be one of the memory nodes involved in the distributed memory transaction.

In a further possible implementation form, the apparatus is configured to perform processing stages (a) and (b) of the validation and commit phase substantially in parallel prior to processing stage (c), wherein the one or more read-set objects comprise a first read-set object stored on a first memory node of the plurality of memory nodes and a second read-set object stored on a second memory node of the plurality of memory nodes, wherein the data processing apparatus is configured to trigger the first memory node and the second memory node to lock the first read-set object and the second read-set object with a shared lock shared by the first memory node and the second memory node. As will be appreciated, in further implementation forms the shared lock may be shared by one or more further memory nodes in addition to the first and the second memory node.

In a further possible implementation form, the apparatus is configured to perform processing stages (b) and (c) of the validation and commit phase substantially in parallel after stage (a), wherein during processing stage (b) the apparatus is configured to trigger the one or more memory nodes of the plurality of memory nodes that store the one or more write-set objects to generate a backup copy of the respective write-set object.

In a further possible implementation form, the apparatus is configured to, in response to receiving from one or more of the plurality of memory nodes information that the validation and commit phase has failed, trigger the one or more memory nodes of the plurality of memory nodes that store the one or more write-set objects to perform a rollback based on the backup copy of the respective write-set object.

In a further possible implementation form, the apparatus is configured to perform processing stages (a). (b) and (c) of the validation and commit phase substantially in parallel. wherein the one or more read-set objects comprise a first read-set object stored on a first memory node of the plurality of memory nodes and a second read-set object stored on a second memory node of the plurality of memory nodes, wherein the data processing apparatus is configured to trigger the first memory node and the second memory node to lock the first read-set object and the second read-set object with a shared lock shared by the first memory node and the second memory node. As will be appreciated, in further implementation forms the shared lock may be shared by one or more further memory nodes in addition to the first and the second memory node.

In a further possible implementation form, the apparatus is configured to perform in a first selectable operation modus processing stages (a) and (b) of the validation and commit phase substantially in parallel, in a second selectable operation modus processing stages (b) and (c) of the validation and commit phase substantially in parallel, and in a third selectable operation modus processing stages (a), (b), and (c) of the validation and commit phase substantially in parallel, wherein the data processing apparatus is configured to select the first, second or third selectable operation modus for managing the distributed memory transaction.

In a further possible implementation form, the apparatus is configured to obtain statistical data of a plurality of distributed memory transactions performed with a previously selected operation modus and to select the first, second or third selectable operation modus for managing the distributed memory transaction based on the statistical data.

In a further possible implementation form, the statistical data obtained, e.g. collected by the apparatus comprises data indicative of a global contention level and/or data indicative of an object contention level.

According to a second aspect a data processing system is provided, wherein the data processing system comprises a plurality of memory nodes and an apparatus according to the first aspect for managing a distributed memory transaction on a plurality of objects stored in the plurality of memory nodes.

According to a third aspect a method is provided for managing a distributed memory transaction on a plurality of objects stored in a plurality of memory nodes of a network of memory nodes, wherein the distributed memory transaction includes an execution phase and a subsequent validation and commit phase and wherein the plurality of objects include one or more read-set objects and/or one or more write-set objects. In the validation and commit phase the method comprises the following processing stages:
(a) locking and validating the one or more write-set objects;
(b) validating the one or more read-set objects; and
(c) committing to changing and unlocking the one or more write-set objects,
wherein the processing stages (a) and (b) and/or the processing stages (b) and (c) of the validation and commit phase are performed substantially in parallel.

The method according to the third aspect of the present disclosure can be performed by the apparatus according to the first aspect of the present disclosure. Thus, further features of the method according to the third aspect of the present disclosure result directly from the functionality of the apparatus according to the first aspect of the present disclosure as well as its different implementation forms described above and below.

According to a fourth aspect a computer program product is provided, comprising a computer-readable storage medium for storing program code which causes a computer or a processor to perform the method according to the third aspect when the program code is executed by the computer or the processor.

Details of one or more embodiments of the present disclosure are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 shows a schematic diagram illustrating a network of memory nodes and a coordinator according to an embodiment of the present disclosure for managing a distributed memory transaction in the network of memory nodes;

FIG. 2 shows a diagram illustrating the interaction between a conventional coordinator and a plurality of memory nodes for a distributed memory transaction;

FIG. 3 shows a diagram illustrating the interaction between a coordinator according to a first embodiment of the present disclosure and a plurality of memory nodes for a distributed memory transaction;

FIG. 4 shows a diagram illustrating the interaction between a coordinator according to a second embodiment of the present disclosure and a plurality of memory nodes for a distributed memory transaction;

FIG. 5 shows a diagram illustrating the operation of a scratchpad by a memory node according to an embodiment of the present disclosure;

FIG. 6 shows a diagram illustrating the interaction between a coordinator according to a third embodiment of the present disclosure and a plurality of memory nodes for a distributed memory transaction;

FIG. 7 shows a diagram illustrating the interaction between a coordinator according to a fourth embodiment of the present disclosure and a plurality of memory nodes for a distributed memory transaction; and

FIG. 8 shows a flow diagram illustrating the selection of a distributed memory transaction mode by a coordinator according to an embodiment of the present disclosure.

In the following, identical reference signs refer to identical or at least functionally equivalent features.

### DETAILED DESCRIPTION

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

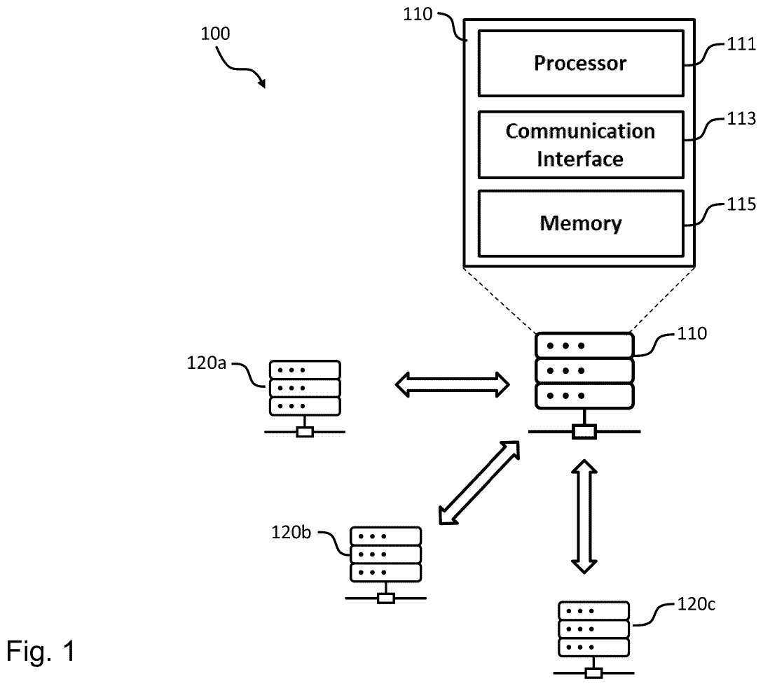

FIG. 1 shows a schematic diagram illustrating a data processing system 100 comprising a plurality of memory nodes 120a-c and an apparatus 110 according to an embodiment of the present disclosure for managing a distributed memory transaction with the plurality of memory nodes 120a-c. The apparatus 110 (which is herein also referred to as a coordinator 110) may be implemented, for instance, as a cloud server, a network interface card (NIC), a memory processor or a hardware accelerator of a cloud server. In an embodiment, the coordinator 110 may be one of the plurality of memory nodes 120a-c of the data processing system 100.

As used herein, a memory transaction comprises one or more operations on (possibly) multiple memory objects within a data structure that is supposed to leave the memory consistent, i.e. either all the operations complete successfully or none of them. A memory transaction may comprise, for example, inserting data into a binary tree involving the manipulation of the content of (possibly) several nodes in the tree. As a further example a memory transaction may comprise inserting data into a doubly linked list involving changing the previous object and the next object pointers.

As used herein, a distributed memory transaction is a memory transaction that accesses memory objects residing on several memory nodes, such as the plurality of memory nodes 120a-c shown in FIG. 1. The memory nodes 120a-c may be, for instance, physical or virtual servers or different processes on the same server.

As illustrated in FIG. 1, the coordinator 110 may comprise processing circuitry 111, a communication interface 113 and/or a memory 115. The processing circuitry 111 may be implemented in hardware and/or software and may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. The communication interface 113 may be configured to communicate with the memory nodes 120a-c via wired and/or wireless connections. The memory 115 of the coordinator 110 may be configured to store executable program code which, when executed by the processing circuitry 111, causes the coordinator 110 to perform the functions and methods described herein.

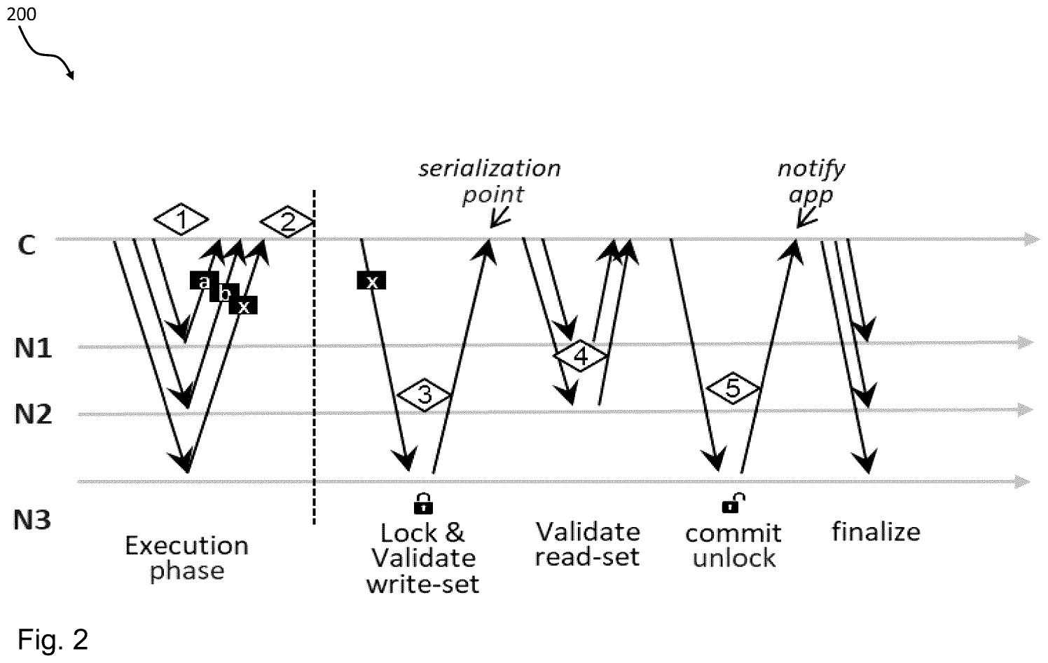

FIG. 2 shows a diagram illustrating the interaction between a conventional coordinator and a plurality of memory nodes for an exemplary distributed memory transaction scheme 200. In the exemplary distributed memory transaction scheme 200 illustrated in FIG. 2 three memory objects are part of the transaction, namely objects a, b that reside in memory nodes N1, N2 respectively and form the read-set (i.e. the objects a and b are only being read during the transaction and their value isn't changed) and object x that resides in memory node N3 and forms the write-set (i.e. the value of the object x is changed during the transaction). The conventional distributed memory transaction scheme 200 illustrated in FIG. 2, which is disclosed in more detail in Dragojevic, A et al “FaRM: Fast Remote Memory”, Proceedings of the 11th USENIX Symposium on Networked Systems Design and Implementation (NSDI '14), Apr. 2-4, 2014, Seattle, WA, USA, is an optimistic concurrency control scheme divided into two main phases, namely an execution phase and a commit and validation phase.

The execution phase of the transaction comprises a sub-step 1 of fetching the values of all read-set objects (a, b, in the example shown in FIG. 2, residing in nodes N1, N2 respectively) and write-set objects (x, residing in node N3) to the central coordinator C and a sub-step 2 of calculating the required changes to the write-set objects (x).

In the commit and validation phase, the central coordinator C takes short-term locks for each of the write-set objects and validates the values of both the read-set objects and the write-set objects. The validation involves checking that the object hasn't changed since it was accessed during the execution phase (for example, using atomically updated version numbers for each object or the like). More specifically, the commit and validation phase comprise the following three sub-steps 3 to 5: in sub-step 3 the coordinator first locks and validates the write-set objects; only if sub-step 3 finishes successfully, the coordinator C validates the read-set objects in sub-step 4; only if sub-steps 3 and 4 are successful, the coordinator C commits in sub-step 5 the changes to the write-set objects and unlocks these objects. Only after unlocking takes place, the coordinator C now informs the calling application (the one that initiated the memory transaction) of the completion of the successful transaction. If any one of the sub-steps 3, 4 or 4 fails, the entire transaction is aborted, nothing is committed and no changes are made in the memory.

As will be appreciated, in the conventional distributed memory transaction scheme 200 shown in FIG. 2 three round trip times (RTTs), namely in the sub-steps 3, 4 and 5, are required before the calling application is notified about a successful transaction. In cases where the network access is slow, this may become a bottleneck in executing and committing the transaction.

As will be described in more detail in the following, the coordinator 110 shown in FIG. 1 is configured to implement a distributed memory transaction scheme 300 according to different embodiments allowing to reduce the execution time of the conventional distributed memory transaction scheme 200 illustrated in FIG. 2. Embodiments of the coordinator 110 disclosed herein improve the commit and validation phase of the distributed memory transaction. More specifically, in the validation and commit phase the coordinator 110 is configured to perform the processing stages: (a) lock and validate the one or more write-set objects; (b) validate the one or more read-set objects; and (c) commit to changing and unlocking the one or more write-set objects. The coordinator 110 is configured to perform the processing stages (a) and (b) and/or the processing stages (b) and (c) of the validation and commit phase substantially in parallel. In an embodiment of the present disclosure, in the execution phase the coordinator 110 is further configured to read an atomic version number of each of the plurality of objects for validating the one or more write-set objects and/or the one or more read-set objects during the validation and commit phase, for instance, by comparing the object version number obtained in the execution phase with the object version number in the validation and commit phase.

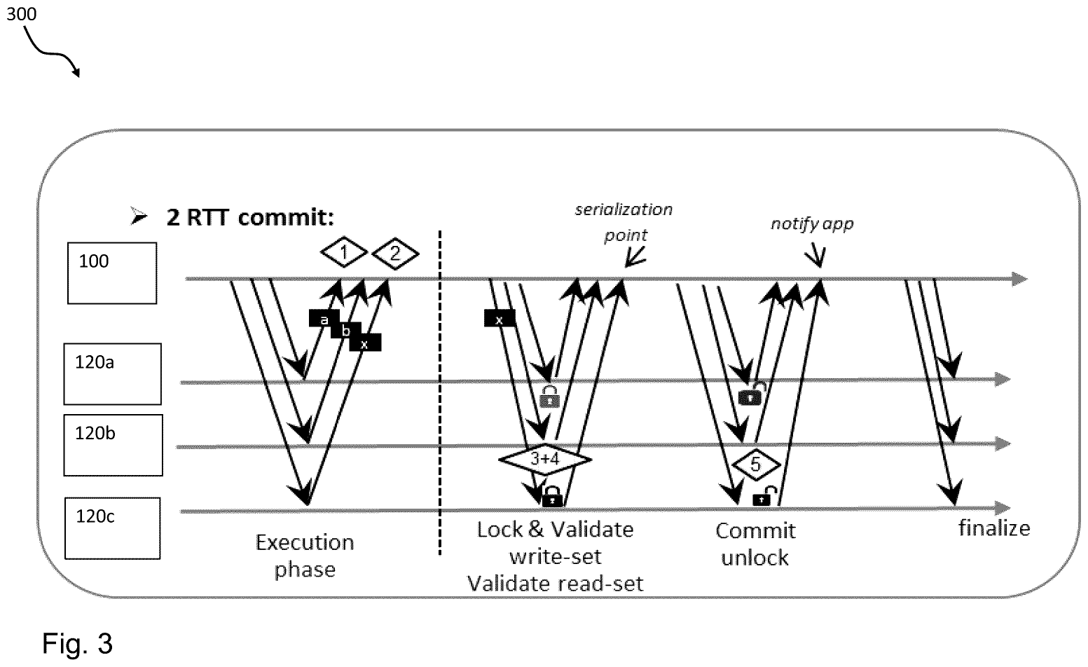

FIG. 3 shows the interaction of the coordinator 110 and, by way of example, the three memory nodes 120a-c for implementing a distributed memory transaction scheme 300 according to a first embodiment of the present disclosure. As will be appreciated from the following more detailed description the distributed memory transaction scheme 300 illustrated in FIG. 3 allows accelerating the commit phase thereof by parallelizing two sub-steps of the conventional distributed memory transaction scheme 200 shown in FIG. 2, in particular by means of managing the locks, validations and commit operations in the way described in the following. The exemplary scenario illustrated in FIG. 3 involves two memory nodes 120a, b with a respective read-set object and one memory mode 120c with a write-set object. As will be appreciated, however, the embodiments disclosed herein may apply to a plurality of memory nodes 120a-c including more than two memory nodes 120a, b having one or more read-set objects and/or more than one memory node 120c having one or more write-set objects.

As can be taken from FIG. 3, in this first embodiment of the present disclosure the write-set validation and locking (i.e. sub-step 3 of FIG. 2) are done in parallel with the read-set validation (i.e. sub-step 4 of FIG. 2) on each memory node 120a-c. In other words. in the first embodiment of the present disclosure shown in FIG. 3 the write-set validation and locking (i.e. sub-step 3 of FIG. 2) and the read-set validation (i.e. sub-step 4 of FIG. 2) are merged for each memory node 120a-c.

The apparatus 110, e.g. coordinator 110 may communicate with the three exemplary memory nodes 120a-c concurrently, instructing each of them to lock and validate the memory objects it owns. In the exemplary scenario illustrated in FIG. 3, the first memory node 120a and the second memory node 120b are instructed by the controller 110 to do so for read-set objects, while the third memory node 120c is instructed by the controller 110 to lock and validate a write-set object. In an embodiment of the present disclosure, short lock periods may be used during the commit phase with diverse lock semantics to allow parallelizing the read-set validation and the write-set locking.

In the first embodiment of the present disclosure shown in FIG. 3, the first memory node 120a and the second memory node 120b are configured to use a shared lock on the respective read-set object they own (as instructed by the controller 110), while the third memory node 120c is configured to exclusively lock the write-set object it owns. As will be appreciated, taking a shared-lock on the read-set objects allows the parallelization of sub-steps 3 and 4 of the validation and commit phase of the distributed memory transaction scheme 300 illustrated in FIG. 3. This is because taking the shared lock by the first memory node 120a and the second memory node 120b allows guaranteeing that the read-set objects will not be changed after the write-set object locks were taken. For comparison in the conventional distributed memory transaction scheme 200 illustrated in FIG. 2 this was achieved by waiting for the write-set locking to complete before starting the read-set validation. As already mentioned above, in further embodiments of the present disclosure, the shared lock may be shared by one or more further memory nodes in addition to the first and the second memory node 120a, b.

In the first embodiment of the present disclosure shown in FIG. 3, the actual changes are committed into the respective memory in sub-step 5 after all validation and locks are done. As will be appreciated, in comparison with the conventional distributed memory transaction scheme 200 illustrated in FIG. 2 the distributed memory transaction scheme 300 of FIG. 3 implemented by the controller 110 and the memory nodes 120a-c according to the first embodiment of the present disclosure allows reducing the network round-trip-time (RTT) during the validation and commit phase and thus shorten the time it takes until the transaction is committed. For an embodiment of the present disclosure, where the distributed memory transaction scheme 300 is performed by a NIC of the controller 110 and/or a respective NIC of each of the memory nodes 120a-c, the synchronization messaging may be offloaded, waiting times for a reaction from a host CPU may be reduced and core cycles may be saved.

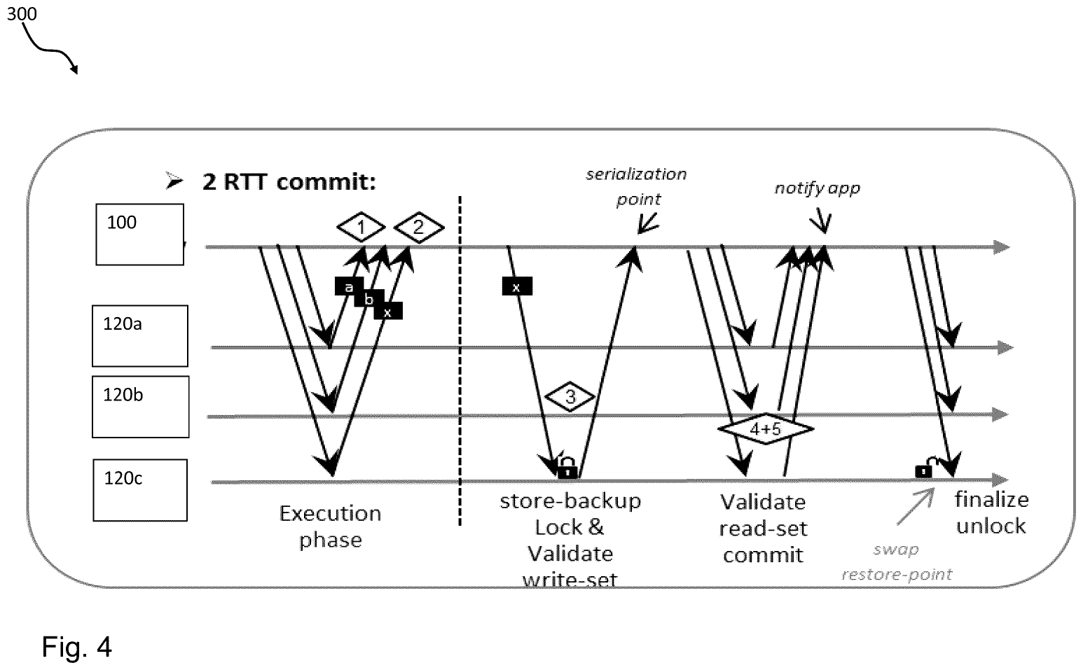

FIG. 4 shows the interaction of the apparatus 110, e.g. the controller 110 and, by way of example, the three memory nodes 120a-c for performing the distributed memory transaction scheme 300 according to a second embodiment of the present disclosure. As will be appreciated from the following more detailed description the distributed memory transaction scheme 300 illustrated in FIG. 4 allows accelerating the validation and commit phase thereof by parallelizing two sub-steps of the conventional distributed memory transaction scheme 200 shown in FIG. 2, in particular by means of managing the locks, validations and commit operations in the way described in the following.

As can be taken from FIG. 4, in this second embodiment the read-set validation (i.e. sub-step 4) and the actual commit (i.e. sub-step 5) are merged, i.e. executed in parallel by each memory node 120a-c. In the exemplary scenario shown in FIG. 4 the coordinator 110 communicates with and instructs the third memory node 120c to lock and validate the write-set object. In an embodiment of the present disclosure, the coordinator 110 may further instruct the third memory node 120c to store a backup version of every write-set object owned by the third memory node 120c.

Once the validation and storing of backups of the write-set object(s) has been successfully completed by the memory node 120c (and reported to the coordinator 110), the coordinator 110 may communicate with all memory nodes 120a-c concurrently for instructing the first memory node 120a and the second memory node 120b to validate the read-set objects of the first memory node 120a and the second memory node 120b and for instructing the third memory node 120c to commit the changes made to the write-set object it has already locked in the previous sub-step 3. As will be appreciated, the parallelization of the read-set validation (i.e. sub-step 4) and the actual commit (i.e. sub-step 5) in the second embodiment of the present disclosure shown in FIG. 4 is made possible by storing a backup version of every write-set object. This allows handling the case of a failure of validating the content of one of the read-set objects while successfully committing a change in some write-set objects by preserving a backup of each write-set object before it is changed. As will be appreciated, this backup allows to rollback changes later on, in case that any of the other parallelized actions fails.

In the second embodiment of the present disclosure shown in FIG. 4, if sub-steps 4 and 5 are completed successfully, the coordinator 110 may notify, for instance, an application about the successful completion of the distributed memory transaction and, subsequently, send an unlock message to all the memory nodes that host a write-set object, such as the third memory node 120c in the exemplary embodiment shown in FIG. 4.

As will be appreciated, in comparison with the conventional distributed memory transaction scheme 200 illustrated in FIG. 2 the distributed memory transaction scheme 300 of FIG. 4 implemented by the controller 110 and the memory nodes 120a-c according to the second embodiment of the present disclosure (like for the first embodiment) allows reducing the network RTT during the validation and commit phase and thus shorten the time it takes until the transaction is committed. For an embodiment of the present disclosure, where the distributed memory transaction scheme 300 is performed by a NIC of the controller 110 and/or a respective NIC of each of the memory nodes 120a-c, the synchronization messaging may be offloaded, waiting times for a reaction from a host CPU may be reduced and core cycles may be saved.

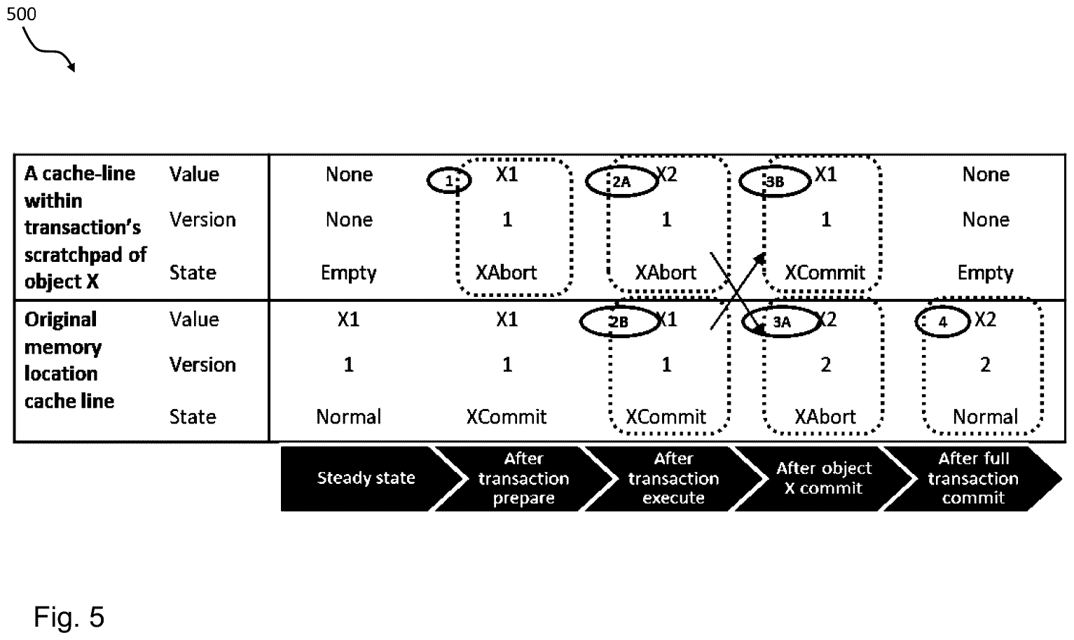

As described above, in the second embodiment of the present disclosure shown in FIG. 4 the third memory node 120c is configured to store a backup version of every write-set object. In an embodiment of the present disclosure, each of the memory nodes 120a-c and in particular the third memory node 120c may store a backup version of the write-set object(s) in a dedicated per-transaction memory space using a data structure for each write-set object in the form of a dual-usage scratchpad 500 illustrated in FIG. 5. That memory space may be allocated during the execution phase and may exist throughout the lifetime of the distributed memory transaction until it either commits or aborts.

In an embodiment of the present disclosure, the scratchpad 500 may be used only for each relevant cache-line of a respective write-set object. In this way, the scratchpad 500 holds only those portions of the write-set object that are actually changed (saving scratchpad memory), which is usually very beneficial when dealing with large write-set objects.

In an embodiment of the present disclosure, each memory node 120a-c is configured to perform, during the execution phase of a distributed memory transaction, all modifications to an object on the scratchpad 500. These changes can be viewed by the corresponding transaction only. All other transactions keep seeing the original content in the memory. Objects that are being modified by concurrent transactions may have concurrent scratchpad images. where eventually only one of the images would be committed to the main memory. Thus, as will be appreciated, in that sense, the usage of the scratchpad 500 is a variation of multi-version concurrency control where each transaction that is accessing an object sees its own scratchpad of the object.

In an embodiment of the present disclosure, for any object that is referenced by a transaction the relevant memory node 120a-c is configured to look the object up in the relevant transaction's scratchpad 500, either for reading or writing. If it is not already there and if it is a write-set object, the respective memory node 120a-c may be configured to copy the content of the write-set object from its original memory location to the scratchpad 500.

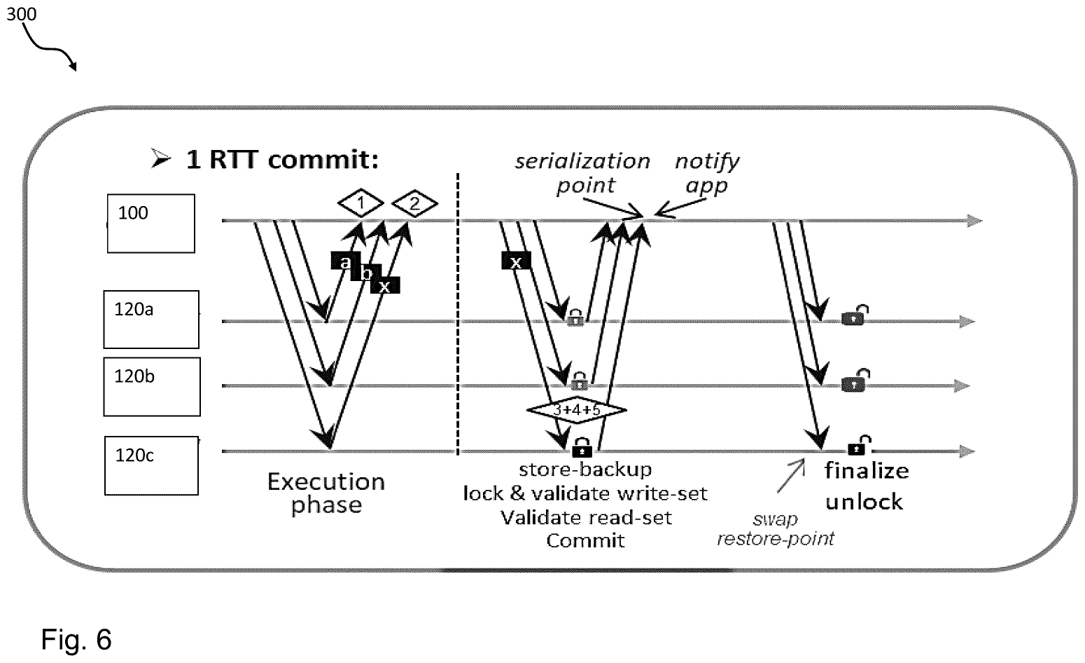

In the second embodiment of the present disclosure shown in FIG. 4 (as well as in a third embodiment of the present disclosure shown in FIG. 6 and described in more detail below) during the validation and commit phase and after taking the write-set object lock in an exclusive mode, the content of the scratchpad 500 of the relevant transaction may be copied to the original memory location of the object and the scratchpad 500 may be filled with the original's memory content for backup purpose, for instance, by using atomic cache line swapping, if supported by the respective memory node 120a-c. Before releasing the lock, the content of the scratchpad 500 may either be cleared up, if the transaction is committed successfully, or copied back to the main memory, if the transaction is aborted.

FIG. 5 illustrates the functionality of the dual-usage scratchpad 500 used by the respective memory node 120a-c for storing respective backups for write-set objects according to an embodiment of the present disclosure. In FIG. 5, the transaction starts with object X data=X1, updates it to be X2 instead and modifying some other objects as well. The transaction is committed successfully. A scratchpad version is created the first time a write-set object is accessed during the execution phase (as illustrated by the box 1 in FIG. 5). Before committing a transaction, the scratchpad content can only be seen by that transaction only (as illustrated by the box 2A in FIG. 5). All other transactions keep seeing the original memory content (as illustrated by the box 2B in FIG. 5). Content in the scratchpad 500 may be discarded if the transaction is aborted (as illustrated by the box XAbort in FIG. 5). The respective memory node 120a-c is configured to copy the content in the scratchpad 500 to the original memory location, if the object is successfully committed (as illustrated by the box 3A in FIG. 5). The scratchpad 500 now holds the original's memory content as a backup (as illustrated by the box 3B in FIG. 5). If the transaction is fully committed, the respective memory node 120a-c may invalidate the scratchpad 500 and the content in memory may be moved to normal state (as illustrated by the box 4 in FIG. 5). If the transaction is aborted, the respective memory node 120a-c may copy the scratchpad content back to the original memory location and thereby overwrite the original memory location. Only then the content on memory may be moved to normal state and the scratchpad 500 is invalidated.

FIG. 6 shows the interaction of the data processing apparatus 110, e.g. the coordinator 110 and, by way of example, the three memory nodes 120a-c for performing the distributed memory transaction scheme 300 according to a third embodiment of the present disclosure. As will be appreciated from the following more detailed description, the distributed memory transaction scheme 300 illustrated in FIG. 6 allows accelerating the validation and commit phase thereof by parallelizing three sub-steps of the conventional distributed memory transaction scheme 200 shown in FIG. 2, in particular by means of managing the locks. validations and commit operations in the way described in the following.

As will be further appreciated, the distributed memory transaction scheme 300 according to the third embodiment of the present disclosure illustrated in FIG. 6 may considered as a combination of the distributed memory transaction scheme 300 according to the first embodiment of the present disclosure illustrated in FIG. 3 (using shared read locks) and the distributed memory transaction scheme 300 according to the second embodiment of the present disclosure illustrated in FIG. 4 (using write-set object backups). More specifically, in the third embodiment of the present disclosure illustrated in FIG. 6 the locking and validating of the read-set objects (sub-step 3), the locking of the write-set objects (sub-step 4) and the commit step (sub-step 5) are executed substantially in parallel by the coordinator 110 and the memory nodes 120a-c. As already described in the context of the second embodiment of the present disclosure shown in FIG. 4, when locking its write-set object(s) in sub-step 4, the third memory node 120c is configured to store a backup version of the write-set object(s) in a dedicated per-transaction memory space using, for instance, the scratchpad data structure 500 illustrated in FIG. 5.

Immediately after the execution phase ends, the coordinator 110 may communicate concurrently with the memory nodes 120a-c instructing the first memory node 120a and the second memory node 120b to validate the read-set objects they own and instructing the third memory node 120c to lock and validate the write-set object it owns, to create a backup thereof (as described above in the context of the second embodiment of the present disclosure using. for instance, the scratchpad data structure 500) and to commit the change into its memory. If all these operations are successful, the coordinator 110 may notify, for instance, the calling application of the successfully committed distributed transaction and send messages to the memory nodes 120a-c to release the locks they have taken. In an embodiment of the present disclosure, short lock periods may be used by the memory nodes 120a-c during the commit phase with diverse lock semantics to allow parallelizing the read-set validation and the write-set locking.

As already described above in the context of the second embodiment of the present disclosure shown in FIG. 4, creating a backup version of every write-set object before committing changes to memory and avoiding unlocking the objects until it has been ensured that all objects have been validated/locked allows parallelizing the commit sub-step 5 with the other sub-steps 3 and 4. If some validation on any of the memory nodes 120a-c fails, that memory node 120a-c may inform the coordinator 110 of the failures, which, in turn, may inform all the other memory nodes 120a-c that they need to rollback changes that were earlier committed by these memory nodes 120a-c (using the backup they preserved, for instance, using the scratchpad data structure 500 described above in the context of FIG. 5).

As will be appreciated, in comparison with the conventional distributed memory transaction scheme 200 illustrated in FIG. 2 the distributed memory transaction scheme 300 of FIG. 6 implemented by the controller 110 and the memory nodes 120a-c according to the third embodiment allows even further reducing the network RTT during the validation and commit phase and thus shorten the time it takes until the transaction is committed. For an embodiment of the present disclosure, where the distributed memory transaction scheme 300 is performed by a NIC of the controller 110 and/or a respective NIC of each of the memory nodes 120a-c, the synchronization messaging may be offloaded, waiting times for a reaction from a host CPU may be reduced and core cycles may be saved.

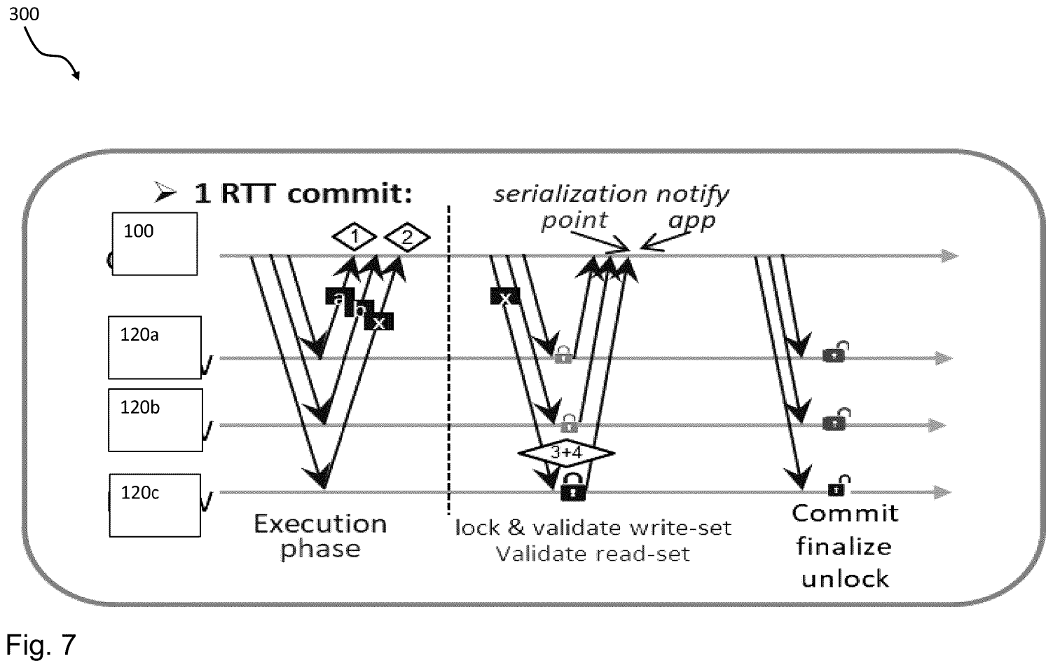

FIG. 7 shows the interaction of the data processing apparatus 110, e.g. the coordinator 110 and, by way of example, the three memory nodes 120a-c for performing the distributed memory transaction scheme 300 according to a fourth embodiment of the present disclosure. As will be appreciated from the following more detailed description, the distributed memory transaction scheme 300 illustrated in FIG. 7 allows accelerating the validation and commit phase thereof by parallelizing three sub-steps of the conventional distributed memory transaction scheme 200 shown in FIG. 2, in particular by means of managing the locks. validations and commit operations in the way described in the following. The distributed memory transaction scheme 300 according to the fourth embodiment of the present disclosure illustrated in FIG. 7 is very similar to the distributed memory transaction scheme 300 according to the third embodiment of the present disclosure illustrated in FIG. 6. The distributed memory transaction scheme 300 illustrated in FIG. 7 differs from the third embodiment of the present disclosure shown in FIG. 6 mainly in that the relevant memory nodes 120a-c are not required to generate and keep backup versions for the write-set object(s) based on the assumption that the actual commit operation (using the memory copy of the write-set object(s)) cannot fail.

More specifically, in the fourth embodiment of the present disclosure illustrated in FIG. 7, the locking and validating of the read-set objects (sub-step 3) and the locking and validation of the write-set objects (sub-step 4) are done in parallel by the memory nodes 120a-c. Once the execution phase ends, the coordinator 110 communicates concurrently with the memory nodes 120a-c, instructing the first and the second memory node 120a,b to validate (and take a shared lock on) the read-set objects they own and instructing the third memory node 120c to lock and validate the write-set object it owns without creating a backup version and without committing. In an embodiment of the present disclosure, short lock periods may be used during the validation and commit phase with diverse lock semantics to allow parallelizing the read-set validation and the write-set locking. If these operations were successful, the coordinator 110 may notify, for instance, a calling application of a successfully committed distributed memory transaction but without releasing the locks yet.

The coordinator 110 sends messages to all the participating memory nodes 120a-c to commit the transaction and release the locks the memory nodes 120a-c have taken. However. in case a validation on any one of the memory nodes 120a-c fails, that memory node 120a-c is configured to inform the coordinator 110 about the failed validation. In response thereto, the coordinator 110 is configured to inform all other memory nodes 120a-c to abort the transaction by not performing the commit operation.

As already described above, in the fourth embodiment of the present disclosure shown in FIG. 7 there is no need for the relevant memory nodes 120a-c to generate backup versions of the write-set object(s) and perform a rollback, because these memory nodes 120a-c are instructed by the coordinator 110 to commit only if all the validations have been successful. As will be appreciated, in that respect the fourth embodiment of the present disclosure of FIG. 7 is similar to the first embodiment of the present disclosure of FIG. 3. However, contrary to the first embodiment of the present disclosure of FIG. 3, according to the fourth embodiment of the present disclosure of FIG. 7 the coordinator 110 is configured not to wait for the actual commit before it informs, for instance, the calling application of a successful transaction. In other words, according to the fourth embodiment of the present disclosure shown in FIG. 7 the coordinator 110 optimistically assumes that the commit will be successful and that the notified applications will be able to access and act upon the results of that transaction once they see that notification (maybe waiting until the locks are released).

As will be appreciated, in comparison with the conventional distributed memory transaction scheme 200 illustrated in FIG. 2 the distributed memory transaction scheme 300 of FIG. 7 implemented by the controller 110 and the memory nodes 120a-c according to the fourth embodiment of the present disclosure allows even further reducing the network RTT during the validation and commit phase and thus shorten the time it takes until the transaction is committed without having to allocate memory space for creating backup versions of every write-set object. For an embodiment of the present disclosure, where the distributed memory transaction scheme 300 is performed by a NIC of the controller 110 and/or a respective NIC of each of the memory nodes 120a-c, the synchronization messaging may be offloaded, waiting times for a reaction from a host CPU may be reduced and core cycles may be saved.

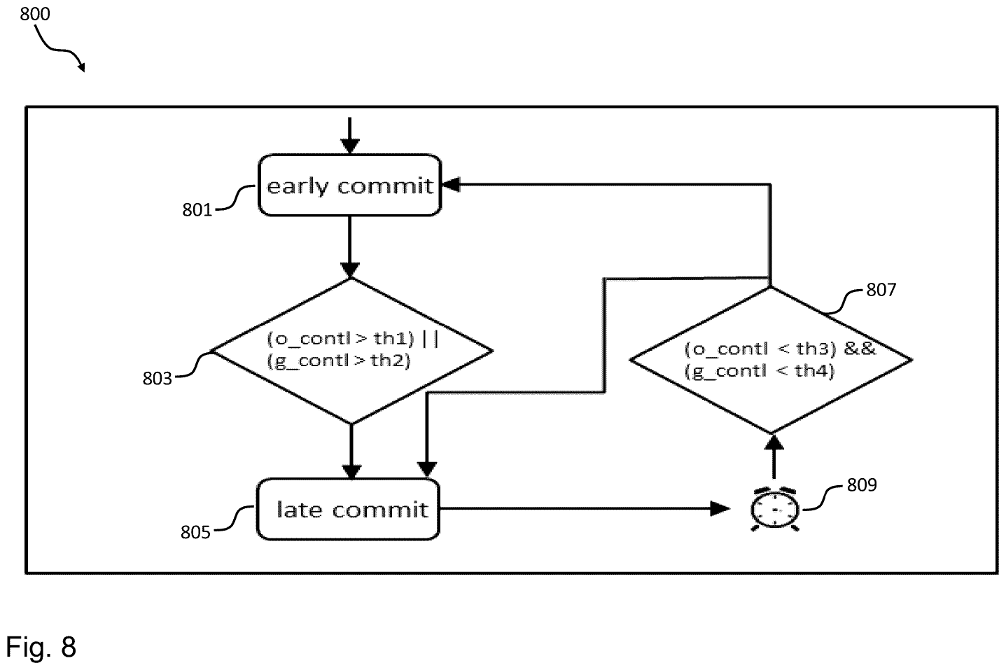

FIG. 8 shows a flow diagram illustrating the operation 800 of the coordinator 110 according to a further embodiment of the present disclosure for dynamically selecting one of the previously described embodiments of the present disclosure as different selectable operation modes for performing the distributed memory transaction based on the actual contention or validation failure ratio in a given implementation scenario. To this end, in an embodiment of the present disclosure, the coordinator 110 is configured to collect statistical data about the performance of the currently used distributed memory transaction mode, i.e. scheme and to potentially switch to a different operation mode based on the statistical data.

As will be appreciated from the description above, the second and third embodiments of the present disclosure of the distributed memory transaction scheme 300 are optimistic operation modes in that they are based on early commit operations done independently and concurrently by the different memory nodes 120a-c. As described above. the distributed memory transaction scheme 300 according to the second and third embodiment of the present disclosure uses backups and a rollback mechanism to preserve a consistent view of the memory while parallelizing to the maximal extent. Thus, the operation modes of the distributed memory transaction scheme 300 according to the second and third embodiment of the present disclosure may rollback a change caused by a transaction made to some object if the transaction is eventually aborted. The main reason for a failed transaction that will eventually be aborted may be a contention on one or more of the locks or a failed validation. If the probability of contention is low, independent (and parallelized) commit tracks may be kept on each of the memory nodes 120a-c and a synchronization may be performed only after all memory nodes 120a-c have finished committing their own parts.

As already described above, the selectable operation mode based on the first embodiment of the present disclosure of the distributed memory transaction scheme 300 does not employ a backup mechanism, because the coordinator 110 waits for all validations and locking to finish before instructing all the memory nodes 120a-c to commit their changes. Although it requires an additional RTT, no memory space for the backup versions of the write-set objects has to be provided. Thus, this operation mode based on the first embodiment of the present disclosure of the distributed memory transaction scheme 300 provides a tradeoff between performance (one saved RTT compared to the conventional distributed memory transaction scheme 200) and usage of memory resources (to preserve the backup versions until the transaction is fully committed or aborted).

As can be taken from FIG. 8, in an embodiment of the present disclosure the coordinator 110 may be configured to operate by default with an early commit operation mode (see 801 in FIG. 8), in particular the operation mode based on the third embodiment of the present disclosure of the distributed memory transaction scheme 300, as this mode is faster and more efficient than the other operation modes. However, if the statistical data collected by the coordinator 110 indicates a bad performance and too many rollbacks (see 803 in FIG. 8), the coordinator 110 may be configured to switch to a late-commit operation mode (see 805 in FIG. 8), for instance, the operation mode based on the first embodiment of the distributed memory transaction scheme 300. Once the global and the object contention level falls below an adjustable threshold value again (see 807 and 809 in FIG. 8), the coordinator 110 may be configured to return to the early commit operation mode (see 801 in FIG. 8), e.g. the operation mode based on the third embodiment of the distributed memory transaction 300, and to reset the collection of statistical data.

In an embodiment of the present disclosure, the resolution of taking the statistical data and the decision-making by the coordinator 110 may be global or per specific memory object. For instance, in the embodiment of the present disclosure shown in FIG. 8, the coordinator 110 is configured to select one of the operation modes based on a global contention level (indicated in FIG. 8 as “g_contl”), which may be determined as the ratio of total number of rollbacks and the total number of successful commits, and/or based on a, object contention level (indicated in FIG. 8 as “o_contl”), which may be determined by a weighted factorization of: (a) the object ratio between rollbacks and successful commits; (b) the object ratio between successful verifications and locking; and/or (c) the object ratio between writes and reads.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present disclosure, it should be understood that the disclosed system, apparatus, and method may be implemented in other manners. The described embodiment of an apparatus is merely exemplary. For example, the unit division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments disclosed herein may be integrated into one processing unit, or each of the units may exist alone physically, or two or more units are integrated into one unit.

What is claimed is:

1. An apparatus for managing a distributed memory transaction on a plurality of objects stored in a plurality of memory nodes of a network of memory nodes, the distributed memory transaction including an execution phase and a validation and commit phase, the plurality of objects including one or more read-set objects and/or one or more write-set objects, wherein in the validation and commit phase the apparatus is configured to perform the processing stages:
(a) lock and validate the one or more write-set objects;
(b) validate the one or more read-set objects; and
(c) commit to changing and unlocking the one or more write-set objects;
wherein the apparatus is configured to perform the processing stages (a) and (b) and/or the processing stages (b) and (c) of the validation and commit phase substantially in parallel.

2. The apparatus of claim 1, wherein in the execution phase the apparatus is further configured to read an atomic version number of each of the plurality of objects for validating the one or more write-set objects and/or the one or more read-set objects during the validation and commit phase.

3. The apparatus of claim 1, wherein the apparatus comprises a network interface card, NIC, a memory processor or a hardware accelerator of a server.

4. The apparatus of claim 1, wherein the apparatus is a memory node of the plurality of memory nodes.

5. The apparatus of claim 1, wherein the apparatus is configured to perform processing stages (a) and (b) of the validation and commit phase substantially in parallel, wherein the one or more read-set objects comprise a first read-set object stored on a first memory node of the plurality of memory nodes and a second read-set object stored on a second memory node of the plurality of memory nodes, wherein the data processing apparatus is configured to trigger the first memory node and the second memory node to lock the first read-set object and the second read-set object with a shared lock.

6. The apparatus of claim 1, wherein the apparatus is configured to perform processing stages (b) and (c) of the validation and commit phase substantially in parallel and wherein during stage (b) the apparatus is configured to trigger the one or more memory nodes of the plurality of memory nodes that store the one or more write-set objects to generate a backup copy of the respective write-set object.

7. The apparatus of claim 6, wherein the apparatus is configured to, in response to receiving from one or more of the plurality of memory nodes information that the validation and commit phase has failed, trigger the one or more memory nodes of the plurality of memory nodes that store the one or more write-set objects to perform a rollback based on the backup copy of the respective write-set object.

8. The apparatus of claim 1, wherein the apparatus is configured to perform the processing stages (a), (b) and (c) of the validation and commit phase substantially in parallel, wherein the one or more read-set objects comprise a first read-set object stored on a first memory node of the plurality of memory nodes and a second read-set object stored on a second memory node of the plurality of memory nodes, wherein the data processing apparatus is configured to trigger the first memory node and the second memory node to lock the first read-set object and the second read-set object with a shared lock.

9. The apparatus of claim 1, wherein the apparatus is configured to perform in a first selectable operation modus the processing stages (a) and (b) of the validation and commit phase substantially in parallel, in a second selectable operation modus the processing stages (b) and (c) of the validation and commit phase substantially in parallel, and in a third selectable operation modus the processing stages (a), (b), and (c) of the validation and commit phase substantially in parallel, and wherein the apparatus is configured to select the first, second or third selectable operation modus for managing the distributed memory transaction.

10. The apparatus of claim 9, wherein the apparatus is configured to obtain statistical data of a plurality of distributed memory transaction performed with a previously selected operation modus and the to select the first, second or third selectable operation modus for managing the distributed memory transaction based on the statistical data.

11. The apparatus of claim 10, wherein the statistical data obtained by the apparatus comprises data indicative of a global contention level and/or data indicative of an object contention level.

12. A data processing system, comprising:
a plurality of memory nodes for storing memory objects; and
an apparatus, wherein the apparatus is configured to manage a distributed memory transaction on a plurality of objects stored in the plurality of memory nodes; the distributed memory transaction including an execution phase and a validation and commit phase, the plurality of objects including one or more read-set objects and/or one or more write-set objects, wherein in the validation and commit phase the apparatus is configured to perform the processing stages:
(a) lock and validate the one or more write-set objects;
(b) validate the one or more read-set objects; and
(c) commit to changing and unlocking the one or more write-set objects;
wherein the apparatus is configured to perform the processing stages (a) and (b) and/or the processing stages (b) and (c) of the validation and commit phase substantially in parallel.

13. A method for managing a distributed memory transaction on a plurality of objects stored in a plurality of memory nodes of a network of memory nodes, the distributed memory transaction including an execution phase and a validation and commit phase, the plurality of objects including one or more read-set objects and/or one or more write-set objects, wherein in the validation and commit phase the method comprises the processing stages:
(a) locking and validating the one or more write-set objects;
(b) validating the one or more read-set objects; and
(c) committing to changing and unlocking the one or more write-set objects,
wherein the processing stages (a) and (b) and/or the processing stages (b) and (c) of the validation and commit phase are performed substantially in parallel.
